(19) United States
(12) Patent Application Publication
(10) Pub. No.: US 2013/0275646 A1
(43) Pub. Date: Oct. 17, 2013

(54) BUS CIRCUIT AND SEMICONDUCTOR DEVICE

(71) Applicant: FUJITSU SEMICONDUCTOR LIMITED, Yokohama (JP)

(72) Inventors: Takashi KAWASAKI, Akiruno (JP); Seiji Goto, Akishima (JP); Takayuki Ootani, Akiruno (JP)

(73) Assignee: Fujitsu Semiconductor Limited, Yokohama (JP)

(21) Appl. No.: 13/780,691

(22) Filed: Feb. 28, 2013

(30) Foreign Application Priority Data
Apr. 16, 2012 (JP) 2012-092771

(51) Int. Cl. G06F 13/40

(52) U.S. Cl. CPC G06F 13/4004
USPC 710/307; 710/305

(57) ABSTRACT

A bus circuit which transfers data of a plurality of bits output from one module to another module, includes: a data bus; a division circuit configured to divide the data into a plurality of pieces of divided data including a plurality of bits in a number equal to or less than half a bit width of the data bus; an inverter circuit configured to generate a plurality of pieces of inverted divided data by inverting each of the plurality of pieces of divided data; an output circuit configured to output each of the plurality of pieces of divided data and each of the pieces of inverted divided data corresponding to each of the pieces of divided data as a data pair; and a coupling circuit configured to extract and couple the plurality of pieces of divided data from the data pair received from the data bus.

### CROSS-REFERENCE TO RELATED APPLICATION

This application is based upon and claims the benefit of priority of the prior Japanese Patent Application No. 2012-092771, filed on Apr. 16, 2012, the entire contents of which are incorporated herein by reference.

### FIELD

The disclosed technique relates to a bus circuit and a semiconductor device.

### BACKGROUND

A side channel attack intended to acquire information inside of an LSI by observing the operating circumstance of a system LIS, etc., from outside by a variety of physical means, such as by observing electromagnetic radiation is known. As a technique to resist the side channel attack, there can be thought of a technique to mount a phase inverter circuit. The phase inverter circuit is a circuit that performs the reverse operation of that of the original circuit (base circuit). If the phase inverter circuit is arranged in the vicinity of the base circuit, the electromagnetic radiations are in reverse phases and cancel out each other. Due to this, the electromagnetic radiation to the surroundings is reduced and observation of the operating circumstances inside of the LSI from outside the LSI is made difficult. It is assumed that the base circuit and the phase inverter circuit include wire, etc., in addition to operating elements such as a transistor.

If the phase inverter circuits are provided in the vicinities of all the base circuits, the electromagnetic radiations cancel out each other over the entire region of the LSI and a high resistance to the side channel attack is achieved, however, the circuit scale becomes a problem. Consequently, in order to reduce the circuit scale of the phase inverter circuit, it can be thought to mount the phase inverter circuit only in part of the base circuits. For example, in a semiconductor device (LSI) that mounts a master module and a slave module, the data bus is liable to become a target of the side channel attack. Because of this, it can be thought to mount the phase inverter circuit only in the data bus.

### RELATED DOCUMENTS

[Patent Document 1] Japanese Laid Open Patent Document No. H09-251336

### SUMMARY

According to an aspect of the embodiments, a bus circuit which transfers data of a plurality of bits output from one module to another module is provide. The bus circuit includes: a data bus; a division circuit; an inverter circuit; an output circuit; and a coupling circuit. The division circuit is configured to divide the data into a plurality of pieces of divided data including a plurality of bits in a number equal to or less than half a bit width of the data bus. The inverter circuit is configured to generate a plurality of pieces of inverted divided data by inverting each of the plurality of pieces of divided data. The output circuit is configured to output each of the plurality of pieces of divided data and each of the pieces of inverted divided data corresponding to each of the pieces of divided data as a data pair. The coupling circuit is configured to extract and couple the plurality of pieces of divided data from the data pair received from the data bus.

The object and advantages of the embodiments will be realized and attained by means of the elements and combination particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1A and FIG. 1B are diagrams each illustrating a configuration example of a system LSI that mounts a phase inverter circuit, wherein FIG. 1A illustrates a basic configuration of the arrangement of the phase inverter circuit for a base circuit 1 and FIG. 1B illustrates a case where the phase inverter circuit is mounted in an LSI 2;

FIG. 2A and FIG. 2B are diagrams each illustrating a configuration example of the system LSI in which the phase inverter circuit is mounted only in the data bus, wherein FIG. 2A illustrates a basic configuration of the arrangement of the phase inverter circuit for the base circuit 1 and FIG. 2B illustrates a case where the phase inverter circuit is mounted in the LSI 2;

FIG. 3A to FIG. 3C are diagrams each illustrating a configuration of a semiconductor device (system LSI) that mounts a bus circuit of a first embodiment, wherein FIG. 3A illustrates a configuration of the base circuit 1, FIG. 3B illustrates a configuration when attention is focused on a write data bus, and FIG. 3C illustrates a configuration when attention is focused on a read data bus.;

FIG. 4A and FIG. 4B are diagrams illustrating circuit configurations of the division circuit and the coupling circuit, wherein FIG. 4A illustrates the circuit configuration of the division circuit and FIG. 4B illustrates the circuit configuration of the coupling circuit;

FIG. 5A and FIG. 5B illustrate a configuration and a time chart illustrating an operation when n=8 in the bus circuit of the first embodiment, wherein FIG. 5A illustrates the configuration of the bus circuit and FIG. 5B illustrates a time chart;

FIG. 6 is a diagram illustrating the configuration of the division circuit of the semiconductor device mounting the bus circuit of the second embodiment;

FIG. 7 is a diagram illustrating the configuration of the coupling circuit 23 of the semiconductor device mounting the bus circuit of the second embodiment;

FIG. 8A and FIG. 8B illustrate a configuration and a time chart illustrating its operation when n=8 and the phase inverter circuit is disabled, wherein FIG. 8A illustrates the configuration of the bus circuit and FIG. 8B illustrates the time chart;

FIG. 9 is a diagram illustrating the configuration of the division circuit of the semiconductor device mounting the bus circuit of the third embodiment;

FIG. 10 is a diagram illustrating a circuit configuration of a parity addition circuit;

FIG. 11 is a diagram illustrating the configuration of the coupling circuit of the semiconductor device mounting the bus circuit of the third embodiment;

FIG. 12A and FIG. 12B illustrate a configuration and a time chart illustrating its operation when n=8 and the phase inverter circuit is enabled in the third embodiment, wherein FIG. 12A illustrates the configuration of the bus circuit and FIG. 12B illustrates the time chart;

FIG. 13A and FIG. 13B are diagrams illustrating a system of Example 1, wherein FIG. 13A illustrates a write data bus and FIG. 13B illustrates a read data bus;

FIG. 14A to FIG. 14D are diagrams each illustrating an arrangement example of a data pair, wherein FIG. 14A illustrates an example in which a data pair is arranged one on top of another, FIG. 14B illustrates an example in which a data pair is arranged horizontally side by side, FIG. 14C illustrates an example in which buses of a data pair are nested one by one in the horizontal direction, and FIG. 14D is a diagram illustrating the section of FIG. 14C, respectively.;

### DESCRIPTION OF EMBODIMENTS

A system LSI (semiconductor device) that mounts a system configured to perform predetermined processing in one package is known.

Such a system LSI performs processing within the package upon receipt of data from outside and outputs data in accordance with the processing result to outside. By the normal method, it is difficult to observe the processing within the semiconductor device (LSI) from outside, and therefore, such a system LSI is advantageous in constructing a system to process confidential information. For example, a secret key is stored within the system LSI in the state where an access from outside is impossible and whether an access is authorized by processing data processed by a public key input from outside, and the determination result is output to outside. However, within the system LSI, the secret key is read and processing using the secret key is performed, and therefore, there is a possibility that the secret key is stolen by the side channel attack at this time. Because of this, such a system LSI is desired to be a security circuit highly resistant to the side channel attack.

In general, the side channel attack is made by exerting an electric or electromagnetic impact on the system LSI from outside, detecting a change in the electromagnetic radiation at this time, and analyzing the signal. Because of this, it is thought that the technique to mount the phase inverter circuit can be applied, which is known as one of the methods for reducing noise generated due to a change in the signal.

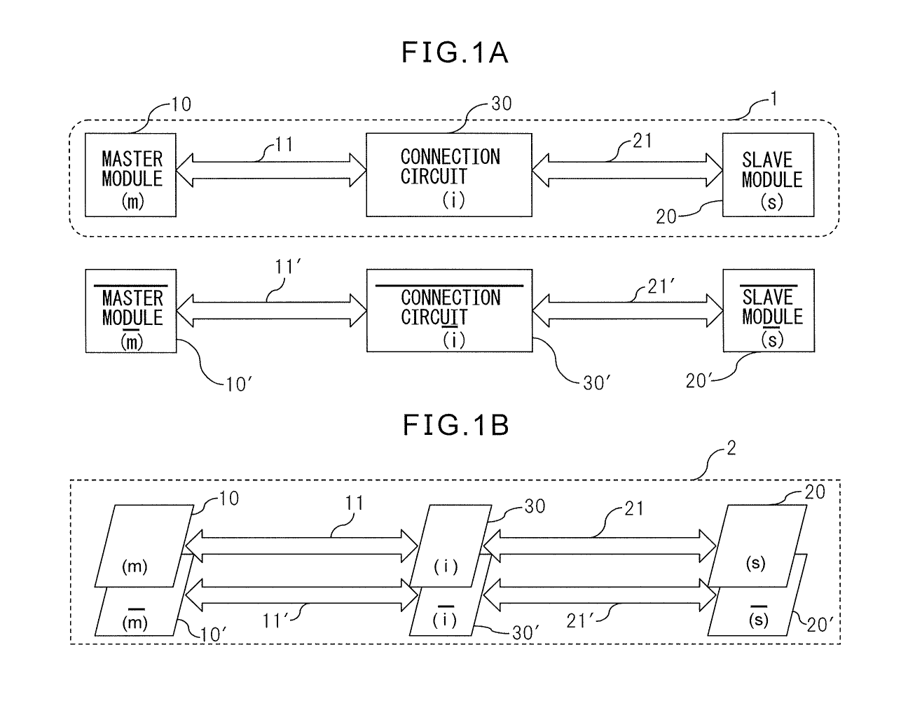

FIG. 1A and FIG. 1B are diagrams each illustrating a configuration example of a system LSI that mounts a phase inverter circuit, wherein FIG. 1A illustrates a basic configuration of the arrangement of the phase inverter circuit for a base circuit 1 and FIG. 1B illustrates a case where the phase inverter circuit is mounted in an LSI 2.

It is assumed that the base circuit 1 is a circuit configured to implement functions originally defined as the specifications of the system LSI. The base circuit 1 has a master module 10, a slave module 20, a connection circuit 30, a bus 11 between the master module 10 and the connection circuit 30, and a bus 21 between the slave module 20 and the connection circuit 30. Between the master module 10 and the connection circuit 30 and between the slave module 20 and the connection circuit 30, a data bus, an address signal bus, a control signal bus, etc., are provided, however, here, attention is focused on the data bus, and therefore, the buses 11 and 12 are data buses. Further, as will be described later, the data bus includes a write data bus and a read data bus.

In general, the master modules 10 and the slave modules 20 are provided in plurality, respectively, and the connection circuit 30 switches the connections of the buses so as to connect the plurality of master modules 10 and the plurality of slave modules 20. Here, in order to simplify explanation, a case is explained as an example, where one master module 10 and one slave module 20 are provided, respectively. In the case where one master module 10 and one slave module 20 are provided, respectively, switching of the bus connection is not provided, and therefore, the connection circuit 30 may be deleted and the configuration of the embodiment can also be applied to such a case. Further, the connections of the buses 11 and 21 are switched by the connection circuit 30 and in the switched state, it is possible to regard them as one connected bus.

The phase inverter circuit is provided in correspondence to each circuit element in the vicinity thereof. As illustrated in FIG. 1A and FIG. 1B, the master module 10 and a/master module 10′, which is the phase inverter circuit thereof, are provide close to each other. Similarly, the slave module 20 and a/slave module 20′, which is the phase inverter circuit thereof, are provided close to each other and the connection circuit 30 and a/connection circuit 30′, which is the phase inverter circuit thereof, are provided close to each other. Further, the bus 11 and a/bus 11′, which is the phase inverter circuit thereof, are provided close to each other and the bus 21 and a/bus 21′, which is the phase inverter circuit thereof, are provided close to each other. By laying out each circuit element of the base circuit 1 and the phase inverter circuit of each circuit element in the vicinity of each other, noise is cancelled and thereby information is prevented from being acquired from outside the LSI.

However, if the phase inverter circuit is mounted in correspondence to each circuit element of the base circuit, the resistance to the side channel attack becomes much stronger, however, the circuit scale increases enormously. Because of this, in order to reduce the circuit scale, it can be thought to mount the phase inverter circuit only in part of the base circuits. In the base circuit, what is most liable to become a target of the side channel attack is the signal bus, which is the path from the master module 10 to the slave module 20. Of the signal buses, the data bus is particularly liable to increase in the wire length because of not having logic due to its nature, and therefore, it is easy to acquire information therefrom and a number of pieces of sensitive information pass therethrough. Because of this, even if the phase inverter circuit is mounted in the data bus, a certain effect can be obtained.

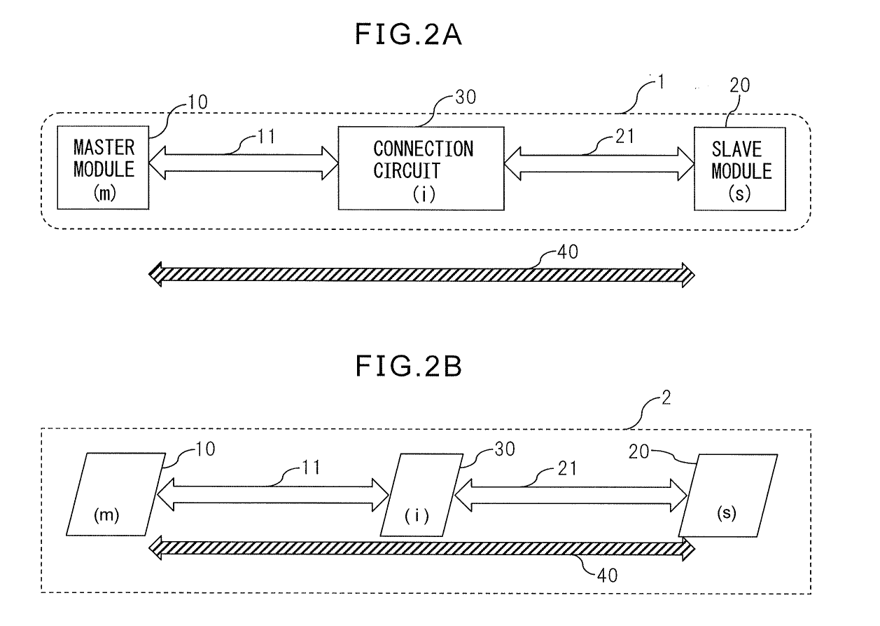

FIG. 2A and FIG. 2B are diagrams each illustrating a configuration example of the system LSI in which the phase inverter circuit is mounted only in the data bus, wherein FIG. 2A illustrates a basic configuration of the arrangement of the phase inverter circuit for the base circuit 1 and FIG. 2B illustrates a case where the phase inverter circuit is mounted in the LSI 2. As illustrated in FIG. 2A and FIG. 2B, a phase inverter circuit 40 of the data bus is provided in the vicinity of the path between the master module 10 and the slave module 20.

By comparing FIGS. 1A and 1B with FIGS. 2A and 2B, it is known that the scale of the phase inverter circuit within the LSI package is reduced more considerably in the case of FIG. 2B. However, the data bus is liable to increase in length of the wire, and therefore, the mounting area for the layout increases. Further, as the data bus width increases due to an increase in the amount of data to be processed in recent years, the circuit scale increases enormously, and therefore, it is desirable to further reduce the circuit scale.

In the bus circuit and the semiconductor device (system LSI) that mounts such a bus circuit of the embodiment explained below, a data bus having improved resistance to the side channel attack is implemented in a comparatively small scale.

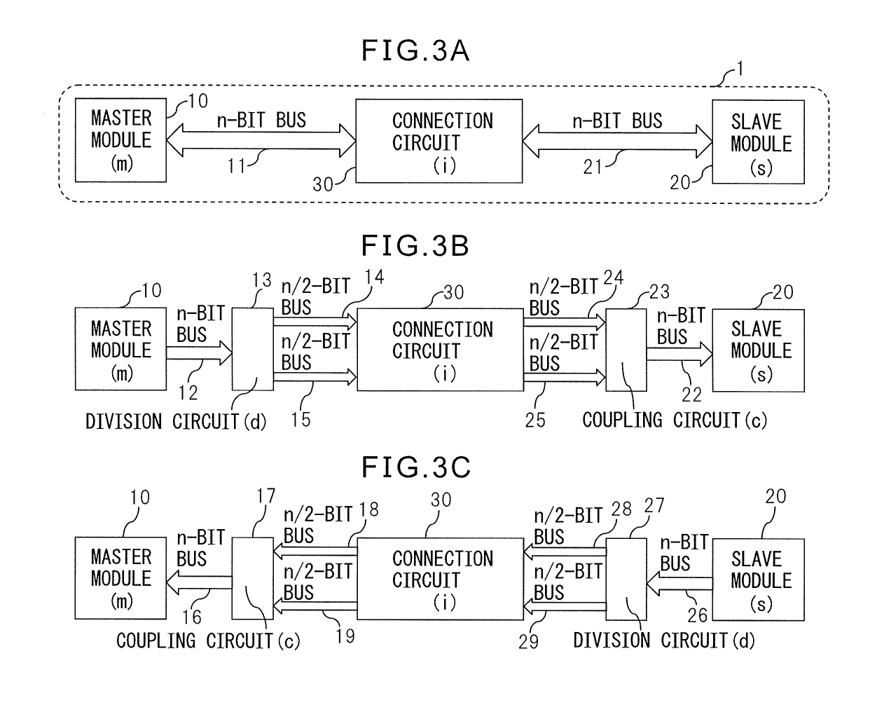

FIG. 3A to FIG. 3C are diagrams each illustrating a configuration of a semiconductor device (system LSI) that mounts a bus circuit of a first embodiment, wherein FIG. 3A illustrates a configuration of the base circuit 1, FIG. 3B illustrates a configuration when attention is focused on a write data bus, and FIG. 3C illustrates a configuration when attention is focused on a read data bus.

As illustrated in FIG. 3A, the base circuit 1 has the master module 10, the slave module 20, the connection circuit 30, and the buses 11 and 21. The bus 11 is an n-bit data bus between the master module 10 and the connection circuit 30. The bus 21 is an n-bit data bus between the slave module 20 and the connection circuit 30.

As described previously, in addition to the data bus, an address signal bus, a control signal bus, etc., are provided, however, attention is focused on the data bus, and therefore, the buses 11 and 21 are illustrated as a data bus. Further, in general, the master modules 10 and the slave modules 20 are provided in plurality, respectively, however, in order to simplify explanation, here, a case is illustrated where one master module 10 and one slave module 20 are connected by the connection circuit 30. When the number of the master modules 10 and that of the slave modules 20 are one, respectively, the connection circuit 30 may be deleted. Each of the buses 11 and 21 includes a write data bus configured to transfer data from the master module 10 to the slave module 20 and a read data bus configured to transfer data from the slave module 20 to the master module 10. The write data bus and the read data bus are independent and data transfer is performed independently in accordance with the transfer direction.

As illustrated in FIG. 3B, in the write data base, a division circuit 13 is provided between the master module 10 and the connection circuit 30 and a coupling circuit 23 between the connection circuit 30 and the slave module 20. Between the master module 10 and the division circuit 13, a write data bus 12 having a width of n bits is provided and between the division circuit 13 and the connection circuit 30, two divided write data buses 14 and 15 having a width of n/2 bits are provided. Between the connection circuit 30 and the coupling circuit 23, two divided write data buses 24 and 25 having a width of n/2 bits are provided and between the coupling circuit 23 and the slave module 20, a write data bus 22 having a width of n bits is provided.

The division circuit 13 divides write data having a width of n bits transferred from the master module 10 via the bus 12 into two pieces of divided write data having a width of n/2 bits and outputs to the buses 14 and 15. The connection circuit 30 connects the buses 14 and 15 and the buses 24 and 25. The coupling circuit 23 couples the two pieces of divided write data having a width of n/2 bits transferred from the connection circuit 30 via the buses 24 and 25 into one piece of write data having a width of n bits and outputs to the bus 22.

As illustrated in FIG. 3C, in the read data base, a coupling circuit 17 is provided between the master module 10 and the connection circuit 30 and a division circuit 27 between the connection circuit 30 and the slave module 20. Between the master module 10 and the coupling circuit 17, a read data bus 16 having a width of n bits is provided and between the coupling circuit 17 and the connection circuit 30, two divided read data buses 18 and 19 having a width of n/2 bits are provided. Between the connection circuit 30 and the division circuit 27, two divided read data buses 28 and 29 having a width of n/2 bits are provided and between the division circuit 27 and the slave module 20, a read data bus 26 having a width of n bits is provided.

The division circuit 27 divides read data having a width of n bits transferred from the slave module 20 via the bus 26 into two pieces of divided write data having a width of n/2 bits and outputs to the buses 28 and 29. The connection circuit 30 connects the buses 28 and 29 and the buses 18 and 19. The coupling circuit 17 couples the two pieces of divided read data having a width of n/2 bits transferred from the connection circuit 30 via the buses 18 and 19 into one piece of read data having a width of n bits and outputs to the bus 16.

One of the two divided write data buses 14 and 15 having a width of n/2 bits operates as a normal data bus and the other operates as a phase inverter circuit of the normal data bus. Similarly, one of the two divided write data buses 24 and 25 having a width of n/2 bits operates as a normal data bus and the other operates as a phase inverter circuit of the normal data bus. One of the two divided read data buses 28 and 29 having a width of n/2 bits operates as a normal data bus and the other operates as a phase inverter circuit of the normal data bus. One of the two divided read data buses 18 and 19 having a width of n/2 bits operates as a normal data bus and the other operates as a phase inverter circuit of the normal data bus.

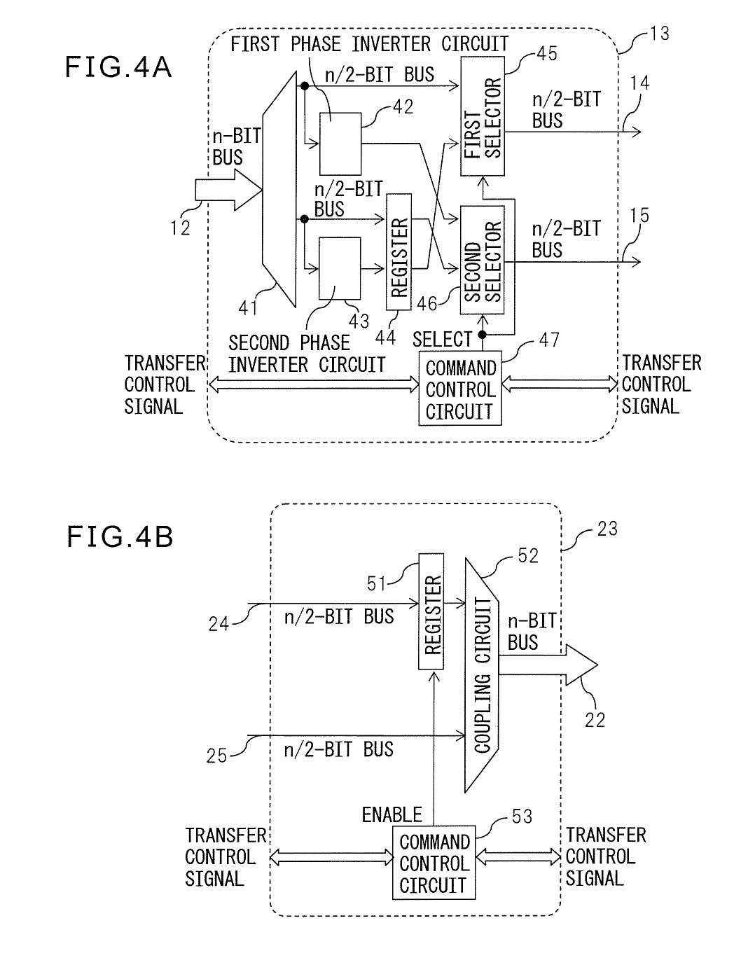

FIG. 4A and FIG. 4B are diagrams illustrating circuit configurations of the division circuit 13 and the coupling circuit 23, wherein FIG. 4A illustrates the circuit configuration of the division circuit 13 and FIG. 4B illustrates the circuit configuration of the coupling circuit 23.

As illustrated in FIG. 4A, the division circuit 13 has a divider 41, a first phase inverter 42, a second phase inverter 43, a register 44, a first selector 45, a second selector 46, and a command control circuit 47.

The divider 41 divides write data having a width of n bits transferred via the bus 12 into first and second divided write data having a width of n/2 bits. The first phase inverter 42 generates phase-inverted data of the first divided write data, that is, first inverted divided write data, which is the first divided write data each bit of which is inverted. The second phase inverter 43 generates phase-inverted data of the second divided write data, that is, second inverted divided write data, which is the second divided write data each bit of which is inverted. The register 44 is a register having a width of n bits and temporarily holds the second divided write data and the second inverted divided write data. The first selector 45 selects and outputs one of the first divided write data output from the divider 41 and the second inverted divided write data output from the register 44 in response to an instruction of the command control circuit 47. The second selector 46 selects and outputs one of the first inverted divided write data output from the first phase inverter 42 and the second divided write data output from the register 44 in response to an instruction of the command control circuit 47. The command control circuit 47 controls the selection operations of the first selector 45 and the second selector 46.

A transfer control signal input to and output from the command control circuit 47 controls the input and output of the command control circuit 47 so that intended data is output from the master module 10 and at the same time, performs protocol control. The protocol control is, for example, control of amount of data to be transferred and there is a case where the amount of data to be transfer is recognized in the connection circuit 30 and at this time, the transfer control signal notifies the command control circuit 47 that, for example, the amount of transfer is twice. The command control circuit 47 controls so that the notified amount of data to be transferred is implemented in the connection circuit 30.

As illustrated in FIG. 4B, the coupling circuit 23 has a register 51, a coupler 52, and a command control circuit 53.

The register 51 temporarily stores one of pieces of the divided write data having a width of n/2 bits, which are transferred from the connection circuit 30 via the bus 24, here, the first divided write data or the second inverted divided write data output from the first selector 45 of the division circuit 13. The coupler 52 selects the output of the register 51 and the other of pieces of divided write data having a width of n/2 bits, which are transferred from the connection circuit 30 via the bus 25, here, the first inverted divided write data or the second divided write data output from the second selector 46 of the division circuit 13. The output of the coupler 52 is output to the write data bus 22 having a width of n bits and transferred to the slave module 20. The command control circuit 53 controls the register 51.

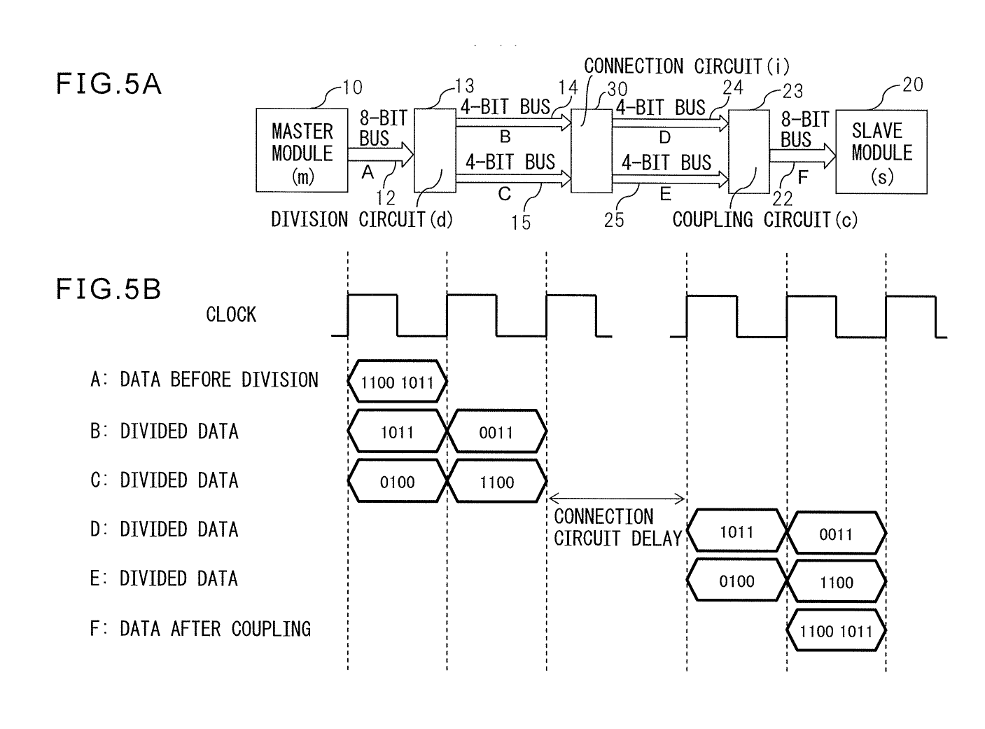

FIG. 5A and FIG. 5B illustrate a configuration and a time chart illustrating an operation when n=8 in the bus circuit of the first embodiment, wherein FIG. 5A illustrates the configuration of the bus circuit and FIG. 5B illustrates a time chart. FIG. 5 and FIG. 5B illustrate a case where the divider 41 divides 8-bit write data into upper 4-bit write data and lower 4-bit write data.

As illustrated in FIG. 5A, A denotes 8-bit write data in the write data bus 12, B denotes 4-bit write data in the write data bus 14, and C denotes 4-bit write data in the write data bus 15. D denotes 4-bit write data in the write data bus 24, E denotes 4-bit write data in the write data bus 25, and F denotes 8-bit write data in the write data bus 22.

The divider 41 receives the 8-bit write data A from the master module 10 via the write data bus 12. Here, it is assumed that the 8-bit write data A=“11001011”.

The divider 41 divides the 8-bit write data A=“11001011” into lower 4-bit write data B=“1011” and upper 4-bit write data C=“1100”. The first phase inverter circuit 42 generates inverted write data=“0100” of the write data B and the second phase inverter circuit 43 generates inverted write data=“0011” of the write data C.

In the first transfer cycle, the first selector 45 selects the write data B=“1011” and the second selector 46 selects the inverted write data=“0100” of the write data B, respectively. Consequently, the original data and the data in which the phase of the original data is inverted are transferred together, and therefore, electromagnetic radiations cancel out each other, and therefore, are reduced.

In the second transfer cycle, the first selector 45 selects inverted write data=“0011” of the write data C and the second selector 46 selects the write data C=“1100”, respectively. Consequently, the original data and the data in which the phase of the original data is inverted are transferred together as a result.

As described above, in the first embodiment, 8-bit write data is halved and transferred in two times and in the first time, the lower 4-bit write data and its inverted data are transferred together and in the second time, the upper 4-bit write data and its inverted data are transferred together. In other words, in the first time, the first divided write data and the first inverted divided write data are transferred and in the second time the second divided write data and the second inverted divided write data are transferred.

The connection circuit 30 connects the divided write data buses 14 and 15 to the divided write data buses 24 and 25, and therefore, the above-mentioned transferred data enters the coupling circuit 23 as it is. Consequently, the original data and the data in which the phase of the original data is inverted are transferred together and they cancel out each other, and therefore, the electromagnetic radiations from the bus from the division circuit 13 to the coupling circuit 23 via the connection circuit 30 are reduced.

In the coupling circuit 23, the register 51 temporarily holds the write data B=“1011” transferred in the first cycle. The inverted write data=“0100” of the write data B is received but not used. During the second cycle, the coupler 52 couples the write data B=“1011” and the write data C “1100” transferred in the second cycle to generate the 8-bit write data F=“11001011” and outputs the data to the slave module 20.

The read data bus has the same configuration as that of the write data bus and operates in the same manner. Specifically, operation will be the same as that given above except in that the master module 10 and the slave module 20 are exchanged, and therefore, explanation is omitted.

In the example described above, n=8 and the bit width is an even number, however, the case where the bit width is an odd number can be dealt with by adding one bit. Further, in the example described above, the bit width is divided into upper bits and lower bits, however, the division method is not limited and, for example, it may also be possible to divide the bit width into an odd number of bits and an even number of bits and the division method may be determined by the division circuit 13. By laying out the divided data buses in the vicinity of each other, noises are cancelled, and therefore, the side channel attack can be resisted. In particular, it is desirable to arrange the bit line corresponding to the original data and that corresponding to its inverted data close to each other and, for example, when forming the data bus by two layers, the bit lines corresponding to the original data and its inverted data are arranged one on top of another.

In the first embodiment, although the transfer rate is reduced compared to the configuration illustrated in FIG. 1 and FIG. 2, it is possible to increase the resistance to the side channel attack only by adding small scale hardware to the portion of the bus circuit.

In a bus circuit of a second embodiment, it is possible for the division circuit 13 and the coupling circuit 23 to switch between causing one of the two divided data buses to operate as a normal data bus and the other as a phase inverter circuit and causing both to operate as the normal data bus by applying a control signal. Because of this, it is possible to maintain the transfer efficiency when security is not desired.

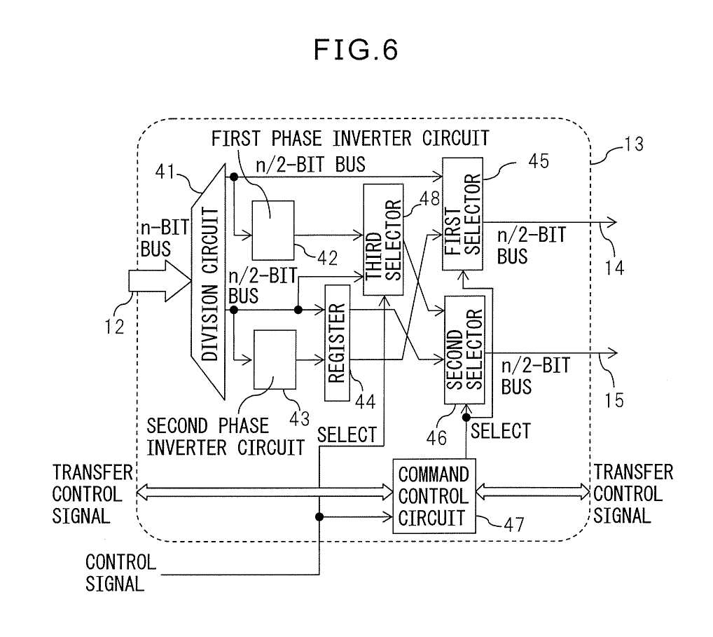

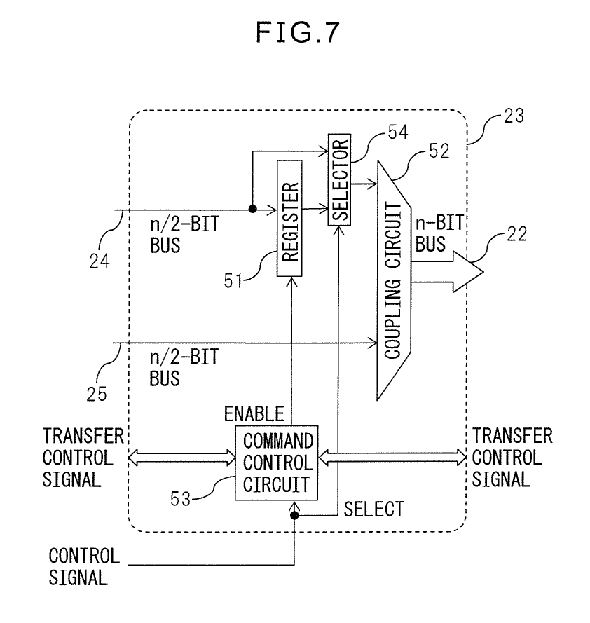

FIG. 6 is a diagram illustrating the configuration of the division circuit 13 of the semiconductor device mounting the bus circuit of the second embodiment. FIG. 7 is a diagram illustrating the configuration of the coupling circuit 23 of the semiconductor device mounting the bus circuit of the second embodiment. The bus circuit of the second embodiment is the same as that of the first embodiment except in the division circuit 13 and the coupling circuit 23.

The division circuit 13 in the second embodiment differs from the division circuit 13 of the first embodiment illustrated in FIG. 4A in that a third selector 48 is added. The coupling circuit 23 in the second embodiment differs from the coupling circuit 23 of the first embodiment illustrated in FIG. 4B in that a selector 54 is added. The selection state of the third selector 48 and the selector 54 is controlled by a control signal. The control signal may be a signal in the bus interface (IF) output from the master module 10 or a signal generated from another circuit as long as it is in the bus system. As the signal in the bus IF output from the master module 10, it is possible to use destination information, sender information, security attribute of the packet, user specification, etc. As another circuit, a control circuit etc. is used by taking into account the register setting and the noise circumstances in the vicinity thereof.

When enabling the phase inverter circuit, the third selector 48 of the division circuit 13 selects the output of the first phase inverter circuit 42 and outputs to the selector 46. The circuit configuration in this case is substantially the same as that of FIG. 4A and the division circuit 13 of the second embodiment operates in the same manner as in the first embodiment. When disabling the phase inverter circuit, the third selector 48 of the division circuit 13 selects the second divided write data having n/2 bits output from the divider 41. Due to this, the n-bit data of the write data bus 12 is transferred to the two divided write data buses 14 and 15 having n/2 bits as it is by one-time transfer operation and substantially, the n-bit write data passes through as it is.

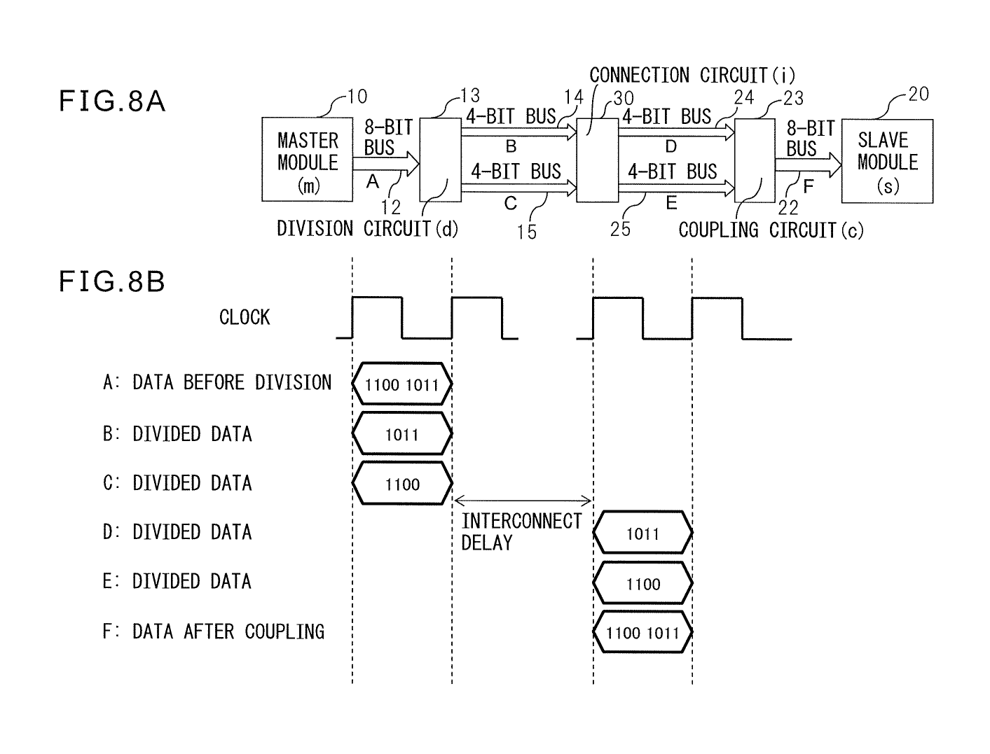

FIG. 8A and FIG. 8B illustrate a configuration and a time chart illustrating its operation when n=8 and the phase inverter circuit is disabled, wherein FIG. 8A illustrates the configuration of the bus circuit and FIG. 8B illustrates the time chart. As described above, when enabling the phase inverter circuit, the configuration and operation are the same as those of FIG. 5A and FIG. 5B.

As illustrated in FIG. 8B, in the division circuit 13, the 8-bit write data A=“11001011” before division is divided into two pieces of 4-bit write data, that is, the 4-bit write data B=“1100” and the 4-bit write data C=“1011”, but they are transferred in parallel. In the coupling circuit 23, the received two pieces of the 4-bit write data D=“1100” and the 4-bit write data E=“1011” are coupled into the 8-bit write data F=“11001011” and output.

The read data bus has the same configuration as that of the write data bus and operates in the same manner. Specifically, explanation will be the same as that given above except in that the master module 10 and the slave module 20 are exchanged, and therefore, explanation is omitted.

As above, in the second embodiment, it is possible to switch between causing the data bus to operate as the normal data bus with the phase inverter circuit disabled and causing the phase inverter circuit to function by a control signal.

In the data transfer, it is known that the occurrence of error can be detected and an error can be corrected by adding a parity bit. In a bus circuit of a third embodiment, an error is detected and corrected by adding a parity bit to data to be transferred.

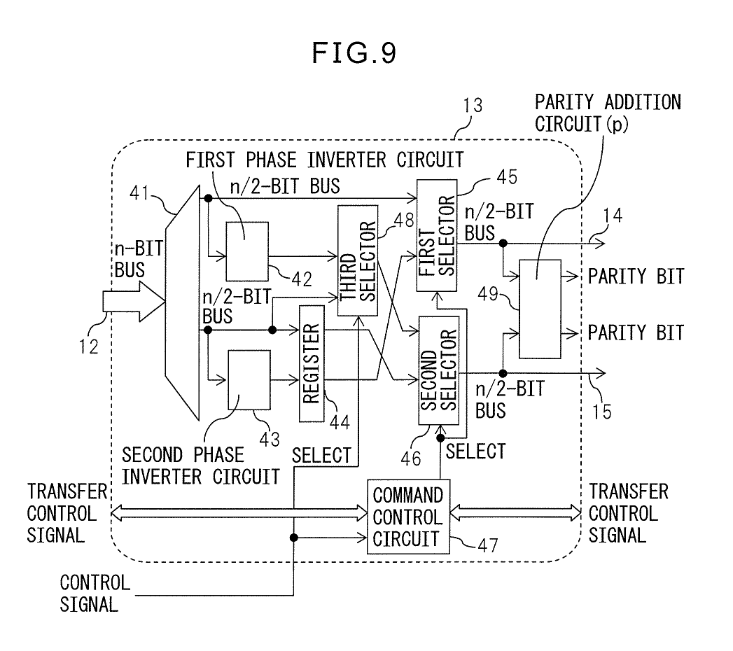

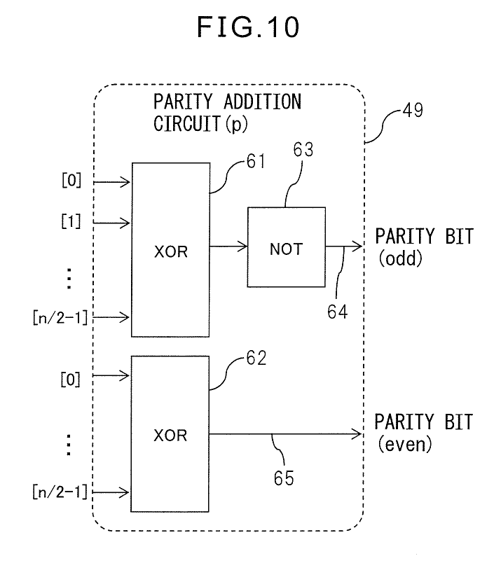

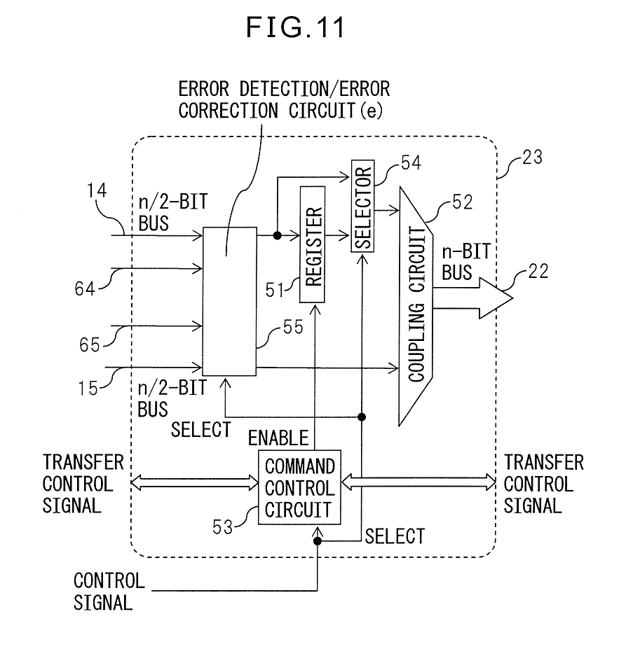

FIG. 9 is a diagram illustrating the configuration of the division circuit 13 of the semiconductor device mounting the bus circuit of the third embodiment. FIG. 10 is a diagram illustrating a circuit configuration of a parity addition circuit. FIG. 11 is a diagram illustrating the configuration of the coupling circuit 23 of the semiconductor device mounting the bus circuit of the third embodiment.

The division circuit 13 in the third embodiment differs from the division circuit 13 of the second embodiment illustrated in FIG. 6 in that a parity addition circuit 49 is added. Further, the coupling circuit 23 in the third embodiment differs from the coupling circuit 23 of the second embodiment illustrated in FIG. 7 in that an error (E) detection/error (E) correction circuit 55 is added. Furthermore, to the data bus from the division circuit 13 to the coupling circuit 23, a data line for transferring a parity bit is added.

The parity addition circuit 49 generates parity bits from the two pieces of the n/2-bit divided write data output from the first selector 45 and the second selector and outputs the parity bits.

As illustrated in FIG. 10, the parity addition circuit 49 has an XOR circuit 61, an XOR circuit 62, and an inverter circuit (NOT) 63. The XOR circuit 61 generates a parity bit by performing the XOR operation of the divided write data output to the divided write data bus 14. The XOR circuit 62 generates a parity bit by performing the XOR operation of the divided write data output to the divided write data bus 14. Both the parity bits generated by the XOR circuit 61 and the XOR circuit 62 are an even parity, and therefore, the parity bit generated by the XOR circuit 61 is inverted into an odd parity in the inverter circuit (NOT) 63.

As illustrated in FIG. 11, in the coupling circuit 23, the error detection/error correction circuit 55 is arranged so as to receive write data of write data buses 64 and 65 and to output the write data to the register 51, the coupler 52, and the selector 54.

In the third embodiment, as in the second embodiment, it is possible to switch between enabling and disabling of the phase inverter circuit. When the phase inverter circuit is disabled, the error detection/error correction circuit 55 outputs the write data from the write data buses 64 and 65 as it is in accordance with the control signal from the command control circuit 53 and does not perform error correction.

When it is specified that the phase is inverted from the command control circuit 53, the error detection/error correction circuit 55 performs error detection and error correction processing. The error detection/error correction circuit 55 generates parity bits for the write data of the write data buses 64 and 65 by performing the same processing as in the parity addition circuit 49 and compares the parity bits with the input parity bits to determine whether they agree with each other. When they agree with each other, the error detection/error correction circuit 55 outputs the write data as it is and on the other hand, when they do not agree with each other, the error detection/error correction circuit 55 inverts the bits of the value of the data bus the parity bit of which agrees with the input parity bit and outputs the value. In this manner, by using the value the parity bit of which agrees with the input parity bit, an error is corrected. When both parity bits do not agree with the input parity bits, the error detection/error correction circuit 55 outputs an error detection signal (not illustrated schematically).

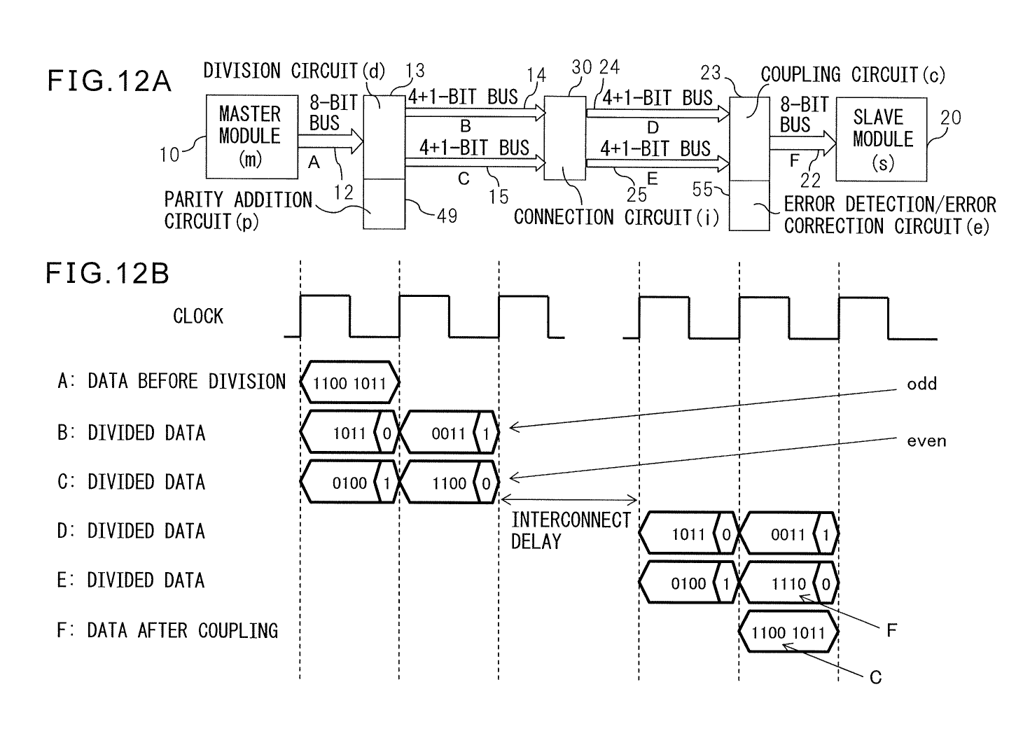

FIG. 12A and FIG. 12B illustrate a configuration and a time chart illustrating its operation when n=8 and the phase inverter circuit is enabled in the third embodiment, wherein FIG. 12A illustrates the configuration of the bus circuit and FIG. 12B illustrates the time chart.

The time chart of FIG. 12B resembles that of FIG. 5B, however, differs in that a parity bit is added.

When the phase inverter circuit is enabled, the first selector 45 and the second selector 46 of the division circuit 13 outputs the 4-bit divided write data and the 4-bit inverted divided write data sequentially. The parity addition circuit 49 generates parity bits of the divided write data and the inverted divided write data by the above-mentioned method and outputs write data to which the parity bits are added.

The error detection/error correction circuit 55 receives the write data to which the parity bits are added. FIG. 12B illustrates an example in which an error has occurred in the second divided write data “1100” transferred in the second time and “1100” has changed into “1110”. The error detection/error correction circuit 55 generates a parity bit for the write data by performing the same processing as that of the parity addition circuit 49 and detects that an error has occurred in “1110” by comparing the parity bit with the input parity bit to determine whether they agree with each other. On the other hand, in the second inverted divided write data “0011”, no error has occurred, and therefore, by inverting the bits of the second inverted divided write data “0011” into “1100”, it is possible to perform error correction. The error detection/error correction circuit 55 outputs the write data the error of which has been corrected.

The method of adding a bit by adding a parity bit is not limited and it is possible to determine a method depending on the mounting method, such as a method of increasing the data bus width and a method of separately providing a signal caused to travel through the data bus. When the divided data bus width is an odd number, the same odd parities or the same even parities are used in both the data buses and when the divided data bus width is an even number, a parity different for each data bus is used. Due to this, the value of the parity bit is opposite for each data bus, and therefore, the party bit is added in such a manner that the phase is inverted and it is possible to resist the side channel attack. When attention is focused on only the function of the error detection/correction, it is possible to implement the function by adding a parity bit to only one of the divided data buses.

In the first to third embodiments explained as above, it is possible to mount the phase inverter circuit for the base circuit only by dividing the data bus and adding the division circuit 13 and the coupling circuit 23, and the side channel attack can be resisted by laying out the divided data buses in the vicinity of each other. The increase in circuit scale due to this is small.

It is possible to switch between causing the data bus to operate as the phase inverter circuit and not causing for each piece of transfer data by a control signal, and therefore, it is possible to maintain the transfer efficiency at the time of transfer not requiring security.

By adding a parity bit to each of the divided data buses, it is possible to perform error detection and error correction of a particularly specified bit on the divided data bus.

The first to third embodiments are explained as above and hereinafter, Example 1 is explained in which the third embodiment is applied to the AMBA AXI® system of the ARM® Ltd.

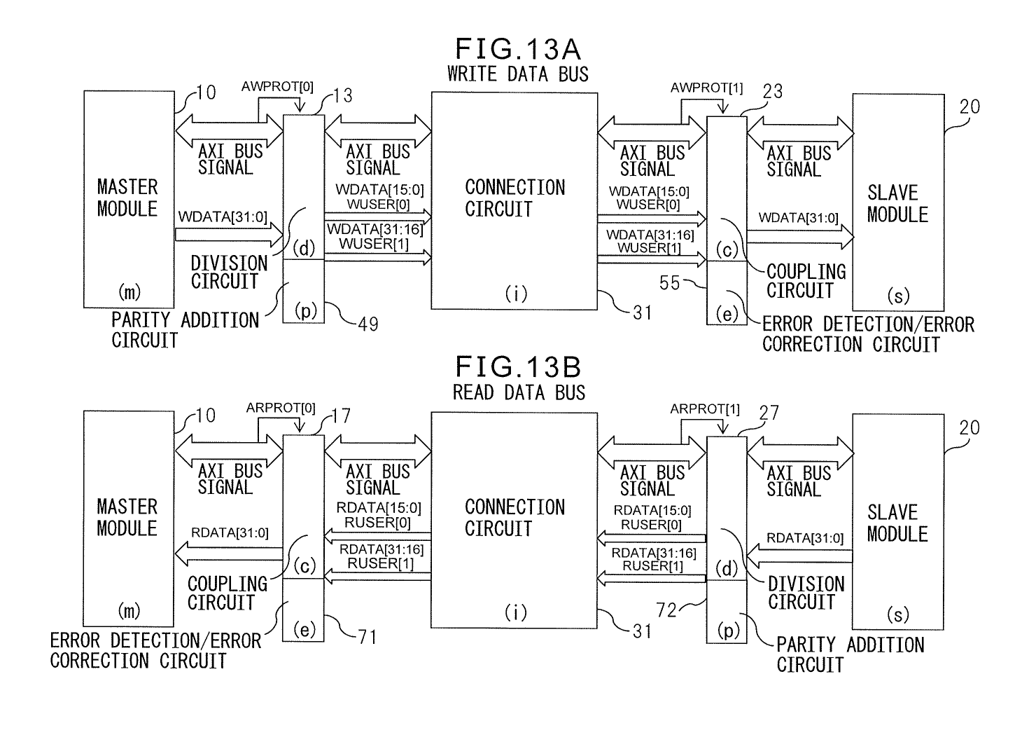

FIG. 13A and FIG. 13B are diagrams illustrating a system of Example 1, wherein FIG. 13A illustrates a write data bus and FIG. 13B illustrates a read data bus.

The AMBA AXI® system has the master module 10, the slave module 20, and an interconnect 31 that connects the master module 10 and the slave module 20. The interconnects corresponds to the connection circuit. In general, the master modules 10 and the slave modules 20 are provided in plurality, respectively, and the interconnect 31 switches the connections of buses so as to connect the plurality of the master modules 10 and the plurality of slave modules 20.

Here, it is assumed that the data bus width is 32 bits, as control signals, AWPROT [0] and ARPROT [0] are used, which are signals representing security attributes of AXI®, and as parity bits, WUSER [1:0] and RUSER [1:0] are used.

First, the operation sequence of write data transfer is explained.

(1) From the master module 10, write data transfer with 32-bit data size occurs and an AXI® bus signal and WDATA are transferred from the master module 10.

(2) The division circuit 13 determines whether this transfer causes the phase inverter circuit to operate by AWPROT [0].

(3) When the determination result is that the phase inverter circuit is not caused to operate, the division circuit 13 does not perform anything on the AXI® bus signal and WDATA and outputs as they are. When the determination result is that the phase inverter circuit is caused to operate, that the number of times of data transfer increases is specified by an AW channel signal in the AXI® bus signal. One pieces of data of WDATA is configured by a combination of the normal data and phase-inverted data and data transfer is performed in two times.

(4) In the parity bit addition circuit 49, as parity bits, WUSER [0] and WUSER [1] are added to each piece of WDATA and each of WDATA is transferred to the interconnect 31.

(5) From the interconnect 31, the AXI® bus signal, WDATA, and WUSER are transferred.

(6) The coupling circuit 23 and the error detection/error correction circuit 55 determine whether the transfer data causes the phase inverter circuit to operate by the control signal included in the AXI® signal.

(7) When the determination result is that the phase inverter circuit is caused to operate, the error detection/error correction circuit 55 performs error detection and error correction using WUSER and WDATA.

(8) When the determination result is that the phase inverter circuit is not caused to operate, nothing is performed on the AXI® signal and WDATA in the coupling circuit 23 and both are transferred to the slave module 20 as they are. When the determination result is that the phase inverter circuit is caused to operate, the coupling circuit 23 specifies so that the number of times of data transfer that has increased in the division circuit 13 returns to the original number by the AXI® bus signal and extracts only the normal data from two pieces of WDATA and generates one coupled piece of WDATA.

(9) The slave module 20 receives write transfer with 32-bit data size.

Next, the operation sequence of read data transfer is explained.

(1) From the master module 10, read transfer with 32-bit data size occurs and the AXI® bus signal is transferred from the master module 10.

(2) The coupling circuit 17 and an error detection/error correction circuit 71 determine whether this transfer causes the phase inverter circuit to operate by ARPROT [0].

(3) When the determination result is that the phase inverter circuit is not caused to operate, nothing is performed on the AXI® bus signal in the division circuit 27. When the determination result is that the phase inverter circuit is caused to operate, that the number of times of data transfer increases is specified by an AR channel signal in the AXI® bus signal.

(4) The division circuit 27 determines whether this transfer causes the phase inverter circuit to operate by the control signal included in the AXI® bus signal.

(5) When the determination result is that the phase inverter circuit is not caused to operate, nothing is performed on the AXI® bus signal and the AXI® bus signal is transferred to the slave module 20 as it is. When the determination result is that the phase inverter circuit is caused to operate, specification is done by the AXI® signal so that the number of times of data transfer that has increased in the coupling circuit 17 returns to the original number.

(6) The slave module 20 receives read transfer with 32-bit data size and RDATA is transferred from the slave module 20.

(7) In the division circuit 27, when the result of determination performed in (4) is that the phase inverter circuit is not caused to operate, nothing is performed on RDATA. When the result of determination performed in (4) is that the phase inverter circuit is caused to operate, RDATA is configured into one piece of data from a combination of the normal data and the phase-inverted data and data transfer is performed in two times.

(8) In the parity bit addition circuit 72, as parity bits, RUSER [0] and RUSER [1] are added to each piece of RDATA and each piece of RDATA is transferred to the interconnect 31.

(9) From the interconnect 31, the AXI® bus signal, RDATA, and RUSER are transferred.

(10) When the result of determination performed in (2) is that the phase inverter circuit is caused to operate, the error detection/error correction circuit 71 performs error detection and error correction using RUSER and RDATA.

(11) When the result of determination performed in (2) is that the phase inverter circuit is not caused to operate, nothing is performed on RDATA in the coupling circuit 17 and RDATA is transferred to the master module 10 as it is. When the result of determination performed in (2) is that the phase inverter circuit is caused to operate, the coupling circuit 17 extracts only the normal data from two pieces of RDATA and generates one coupled piece of RDATA.

(12) The master module 10 receives read data with 32-bit data size.

As the control signal that indicates whether the phase inverter circuit is caused to operate, other signals can be used in the AXI® bus signal other than AWPROT [0]/ARPROT [0]. For example, AWADDR/ARADDR (put into operation at a specific address), AWID/ARID (put into operation at a specific ID value), AWUSER/ARUSER (put into operation when specified by a user), etc., can be used.

As above, the example is explained in which transfer data is divided into two pieces of data and a pair is formed with phase-inverted data and the pair is transferred in two times, however, it may also be possible to divide transfer data into three or more pieces of data.

A data pair is arranged so that the corresponding bit lines are close to each other, that is, they are in the vicinity of each other, however, various kinds of modification can be made to the arrangement.

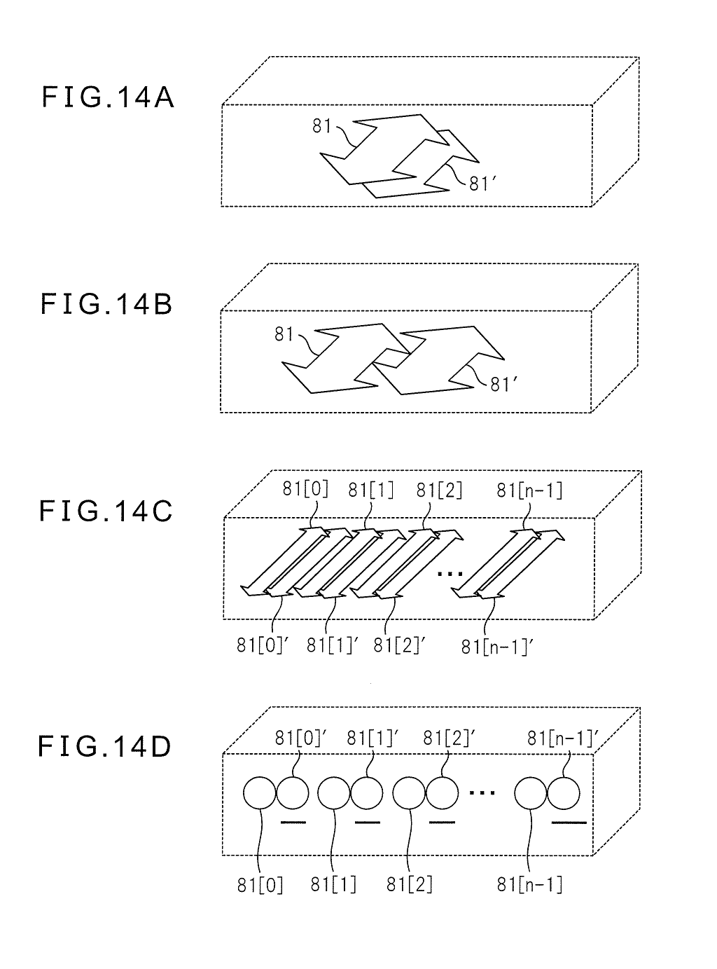

FIG. 14A to FIG. 14D are diagrams each illustrating an arrangement example of a data pair, wherein FIG. 14A illustrates an example in which a data pair is arranged one on top of another, FIG. 14B illustrates an example in which a data pair is arranged horizontally side by side, FIG. 14C illustrates an example in which buses of a data pair are nested one by one in the horizontal direction, and FIG. 14D is a diagram illustrating the section of FIG. 14C, respectively.

In the example of FIG. 14A, a bus 81 that transfers one of the data pair and a bus 81′ that transfers the other are arranged so that the corresponding bit lines neighbor each other vertically.

In the example of FIG. 14B, the bus 81 that transfers one of the data pair and the bus 81′ that transfers the other are arranged horizontally side by side. In this case, the corresponding bit lines are arranged a distance apart corresponding to the bus 81 or the bus 81′, however, the data transferred by the bus as a whole is in reverse phases and the resistance to the side channel attack is improved.

In the example of FIG. 14C, bit lines 81[0], 81[1], 81[2], . . . , 81[n-1] of the bus 81 that transfers one of the data pair and bit lines 81[0]′, 81[1]′, 81[2]′, 81[n-1]′ of the bus 81′ that transfers the other are nested one by one in the horizontal direction. In the section of the bus in this case, the bit lines are arranged as illustrated in FIG. 14D. In this example, compared to the example of FIG. 14B, the resistance to the side channel attack is further improved.

When referring to the arrangement in which a data pair, that is, data buses are arranged in the vicinity of each other, all the modification examples illustrated in FIG. 14A to FIG. 14D etc. are included.

As described above, according to embodiments, a circuit that resists the side channel attack is implemented in a comparatively small scale.

All examples and conditional language provided herein are intended for pedagogical purposes of aiding the reader in understanding the invention and the concepts contributed by the inventor to furthering the art, and are to be construed as limitations to such specifically recited examples and conditions, nor does the organization of such examples in the specification relate to a illustrating of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A bus circuit which transfers data of a plurality of bits output from one module to another module, comprising:
a data bus;
a division circuit configured to divide the data into a plurality of pieces of divided data including a plurality of bits in a number equal to or less than half a bit width of the data bus;
an inverter circuit configured to generate a plurality of pieces of inverted divided data by inverting each of the plurality of pieces of divided data;
an output circuit configured to output each of the plurality of pieces of divided data and each of the pieces of inverted divided data corresponding to each of the pieces of divided data as a data pair; and
a coupling circuit configured to extract and couple the plurality of pieces of divided data from the data pair received from the data bus.

2. The bus circuit according to claim 1, wherein
the output circuit is capable of selecting an output state between outputting the data pair sequentially to the data bus and outputting the plurality of pieces of divided data simultaneously to the data bus,
a signal line which transfers a control signal indicating the output state of the output circuit is further provided, and
the coupling circuit changes processing to extract and couple the plurality of pieces of divided data based on the control signal from the signal line.

3. The bus circuit according to claim 1, wherein
the data bus includes a first divided data bus and a second divided data bus each having bits in a number half the bit width of the data bus,
each of the pieces of divided data is transferred by one of the first divided data bus and the second divided data bus, and inverted divided data corresponding to each of the pieces of divided data is transferred by the other of the first divided data bus and the second divided data bus, and
the first divided data bus and the second divided data bus are arranged in the vicinity of each other.

4. The bus circuit according to claim 2, wherein
the data bus includes a first divided data bus and a second divided data bus each having bits in a number half the bit width of the data bus,
each of the pieces of divided data is transferred by one of the first divided data bus and the second divided data bus, and inverted divided data corresponding to each of the pieces of divided data is transferred by the other of the first divided data bus and the second divided data bus, and
the first divided data bus and the second divided data bus are arranged in the vicinity of each other.

5. The bus circuit according to claim 1, wherein
the output circuit includes a parity circuit configured to add a parity bit to data transferred by the first divided data bus and the second divided data bus, and
the data bus includes a signal line to transfer the parity bit.

6. The bus circuit according to claim 4, wherein
the output circuit includes a parity circuit configured to add a parity bit to data transferred by the first divided data bus and the second divided data bus, and
the data bus includes a signal line to transfer the parity bit.

7. The bus circuit according to claim 5, wherein
the coupling circuit performs error detection or error correction based on the transferred parity bit.

8. The bus circuit according to claim 6, wherein
the coupling circuit performs error detection or error correction based on the transferred parity bit.

9. A semiconductor device comprising a write bus circuit configured to transfer write data output from a first module to a second module and a read bus circuit configured to transfer read data output from the second module to the first module, wherein
each of the write bus circuit and the read bus circuit is a bus circuit comprising:
a data bus;
a division circuit configured to divide the data into a plurality of pieces of divided data including a plurality of bits in a number equal to or less than half a bit width of the data bus;
an inverter circuit configured to generate a plurality of pieces of inverted divided data by inverting each of the plurality of pieces of divided data;
an output circuit configured to output each of the plurality of pieces of divided data and each of the pieces of inverted divided data corresponding to each of the pieces of divided data as a data pair; and
a coupling circuit configured to extract and couple the plurality of pieces of divided data from the data pair received from the data bus.

10. The semiconductor device according to claim 9, wherein
the output circuit is capable of selecting an output state between outputting the data pair sequentially to the data bus and outputting the plurality of pieces of divided data simultaneously to the data bus,
a signal line which transfers a control signal indicating the output state of the output circuit is further provided, and
the coupling circuit changes processing to extract and couple the plurality of pieces of divided data based on the control signal from the signal line.

11. The semiconductor device according to claim 9, wherein
the data bus includes a first divided data bus and a second divided data bus each having bits in a number half the bit width of the data bus,
each of the pieces of divided data is transferred by one of the first divided data bus and the second divided data bus, and inverted divided data corresponding to each of the pieces of divided data is transferred by the other of the first divided data bus and the second divided data bus, and
the first divided data bus and the second divided data bus are arranged in the vicinity of each other.

12. The semiconductor device according to claim 10, wherein
the data bus includes a first divided data bus and a second divided data bus each having bits in a number half the bit width of the data bus,
each of the pieces of divided data is transferred by one of the first divided data bus and the second divided data bus, and inverted divided data corresponding to each of the pieces of divided data is transferred by the other of the first divided data bus and the second divided data bus, and
the first divided data bus and the second divided data bus are arranged in the vicinity of each other.

13. The semiconductor device according to claim 9, wherein
the output circuit includes a parity circuit configured to add a parity bit to data transferred by the first divided data bus and the second divided data bus, and
the data bus includes a signal line to transfer the parity bit.

14. The semiconductor device according to claim 12, wherein
the output circuit includes a parity circuit configured to add a parity bit to data transferred by the first divided data bus and the second divided data bus, and
the data bus includes a signal line to transfer the parity bit.

15. The bus circuit according to claim 14, wherein
the coupling circuit performs error detection or error correction based on the transferred parity bit.

16. A semiconductor device comprising a plurality of first modules, a plurality of second modules, and a connection circuit configured to switch connections of bus of the plurality of the first modules and the bus of the plurality of the second modules, wherein
each of the bus of the plurality of the first modules and the bus of the plurality of the second modules is a bus circuit comprising:
a data bus;
a division circuit configured to divide the data into a plurality of pieces of divided data including a plurality of bits in a number equal to or less than half a bit width of the data bus;
an inverter circuit configured to generate a plurality of pieces of inverted divided data by inverting each of the plurality of pieces of divided data;
an output circuit configured to output each of the plurality of pieces of divided data and each of the pieces of inverted divided data corresponding to each of the pieces of divided data as a data pair; and
a coupling circuit configured to extract and couple the plurality of pieces of divided data from the data pair received from the data bus.

17. The semiconductor device according to claim 16, wherein
the output circuit is capable of selecting an output state between outputting the data pair sequentially to the data bus and outputting the plurality of pieces of divided data simultaneously to the data bus,
a signal line that transfers a control signal indicating the output state of the output circuit is further provided, and
the coupling circuit changes processing to extract and couple the plurality of pieces of divided data based on the control signal from the signal line.

18. The semiconductor device according to claim 17, wherein
the data bus includes a first divided data bus and a second divided data bus each having bits in a number half the bit width of the data bus,
each of the pieces of divided data is transferred by one of the first divided data bus and the second divided data bus, and inverted divided data corresponding to each of the pieces of divided data is transferred by the other of the first divided data bus and the second divided data bus, and
the first divided data bus and the second divided data bus are arranged in the vicinity of each other.

19. The semiconductor device according to claim 18, wherein
the output circuit includes a parity circuit configured to add a parity bit to data transferred by the first divided data bus and the second divided data bus, and
the data bus includes a signal line to transfer the parity bit.

20. The bus circuit according to claim 19, wherein
the coupling circuit performs error detection or error correction based on the transferred parity bit.
